(19) United States
(12) Patent Application Publication
(10) Pub. No.: US 2007/0009389 A1
(43) Pub. Date: Jan. 11, 2007

(54) Slide deposition chamber

(76) Inventors: Antti Seppo, Bronx, NY (US); Triantafyllos P. Tafas, Rocky Hill, CT (US); Michael W. Kilpatrick, West Hartford, CT (US)

Correspondence Address: KELLEY DRYE & WARREN LLP, TWO STAMFORD PLAZA, 281 TRESSER BOULEVARD, STAMFORD, CT, 06901, US

(21) Appl. No.: 11/177,036

(22) Filed: Jul. 8, 2005

(51) Int. Cl. B05B 1/28; B01L 3/00

(52) U.S. Cl. 422/99; 118/326; 422/104

(57) ABSTRACT

A cell deposition chamber and a method for depositing a biological sample on a microscope slide using the chamber. The chamber is removably sealed onto a sample receiving area on the slide and has a sealable opening to allow aspiration of the sample from the slide surface. The chamber is configured to allow the aspiration of all areas of the slide surface by a pipette and the chamber drains fully when inverted. The chamber can be fitted with a disposable liner to make the chamber reusable.

### FIELD OF INVENTION

This invention is related to depositing biological materials onto a microscope slide. More particularly, the present invention is related to an apparatus and a method for depositing various materials onto a microscope slide using a deposition chamber. The chamber may be disposable or nondisposable, that is, reusable, as disclosed in the embodiments of the present invention.

### BACKGROUND OF INVENTION

Diagnostic processes that are performed in laboratories commonly start with collecting biological material specimens from patients. The specimens may include, but are not limited to blood, saliva, urine, epithelial smears, semen, and the like. Methods exist for depositing these specimens in the form of fixed cells or cell nuclei on microscope slides from suspensions for the purpose of immunocytochemical, immunofluorescence or FISH (Fluorescence In Situ Hybridization) staining and subsequent microscopic analysis. The deposition methods vary depending upon the application.

For example, smearing may be used for depositing blood samples on a slide for microscopic analysis. Smearing may entail placing a drop of a few microliters of anticoagulant treated blood on one end of a slide and smearing the blood in one motion using another clean slide. Properly performed, the smearing forms a relatively even monolayer of blood cells covering most of the slide surface. The slide is then allowed to dry in ambient conditions. The drying process primarily attaches cells to the glass slide. Preparation of a blood smear may be a highly user dependent process. Smearing may be used in preparing whole blood slides. Attempts to automate this process have been largely unsuccessful.

Another approach involves the “dropping” method. Dropping is a common method to prepare fixed nuclei for FISH analysis from cells of various origins including amniotic fluid, blood and bone marrow aspirates. These cells may be primary cells from the sample or cultured cells. The sample may be suspended in organic solvent such as the Carnoy fixative (3:1 methanol:acetic acid).

The fixed nuclear suspension may be dropped in a single drop on a glass slide from a predetermined height (usually 15-20 cm). As a result of the impact of the drop onto the slide, the suspension may spread in a concentric manner to cover the width of the slide, depending upon the height from which the suspension is dropped. The solvent is then allowed to evaporate which results in nuclei adhering to the slide provided the glass is clean and suitably treated. However, the pattern and position of deposition is unpredictable, and the amount of sample deposited can only partially be controlled. The distribution of cells and the resulting density on the slide is generally unpredictable. If quantization and systematic scanning of nuclei is not desired, however, this method is in most cases adequate.

In order to gain better control of the deposition pattern and to allow automation of the sample deposition process, methods using centrifugal force in placing the cells or nuclei on the slide have been developed. Centrifugation by using adjustable force to place cells on slide may also allow attachment of some sample types that otherwise would not attach to the slide surface. A centrifugation device, called Cytospin, designed for depositing material on a microscope slide in a dedicated centrifuge is manufactured by Shandon Corporation and is shown in FIG. 1.

Cytospin 10 comprises a chamber 20, which accepts a slide 30 and is mountable onto a holder/bracket 40 as shown in FIG. 1. The chamber is placed in a position where the slide is slightly tilted and sample suspension is loaded through opening or port 50 with the aid of a pipette 60 (FIG. 2a). Suspension liquid 70 contains suspended cells 75. Suspended cells start immediately sedimenting with a settling speed that can be predicted by variants of the well-known Stoke's equation. Thus, an initial pellet comprising cells 75 is formed at the bottom of the Cytospin chamber as shown in FIG. 2a, the size of which is proportional to the time between loading the chamber and starting the centrifugation. The whole Cytospin assembly 10 (chamber 20-slide 30-holder 40) is next placed in a centrifuge (not shown). Upon acceleration of the centrifuge, and under the influence of centrifugal forces 80, liquid 70 gradually rises to a vertical position as shown in FIG. 2b. During centrifugation, the suspension liquid is compressed against slide 30 and cells pressed onto the slide shown in FIG. 2c. When centrifuge then stops, cells 75 are left attached to slide 30 and the remaining supernatant suspension liquid 70 flows back to its original position in chamber 20 as shown in FIG. 2d.

An apparatus and a method for using a centrifuge to apply a treatment liquid, such as a fixative agent, to a specimen undergoing centrifugation analysis are described by W. J. Hayes in U.S. Pat. No. 5,942,129. There is provided a centrifuge sample chamber with a mounting flange for engagement with a microscope slide, so that specimen material is centrifuged to the slide for inspection. The sample chamber has an upper cavity and a lower specimen holding portion which are connected by a fluid passage. The specimen holding portion includes a lower cavity with a lower leg extending down therefrom for holding the specimen prior to centrifugation. An upper hollow leg in communication with the upper cavity holds the treatment liquid while the chamber is at rest prior to centrifugation. Activation of the centrifuge tilts the chamber to incline the upper and lower legs, so that the treatment liquid flows into, and is held within, the upper cavity by centrifugal force. Centrifugal forces simultaneously cause the specimen to flow out of the lower leg, through the lower cavity and through a discharge port, and to the microscope slide. Upon deactivation of the centrifuge, the chamber tilts by gravity back to the rest position, allowing the treatment liquid to fall by gravity from the upper cavity, through the passage, and into the lower leg. Reactivation of the centrifuge again tilts the chamber to incline the lower leg, and centrifugal forces cause the treatment liquid to flow out of the lower leg and through the discharge port for centrifugal application to the specimen on the microscope slide.

Another device for placing solid matters on a slide glass under centrifugal force is provided by M. Toya in U.S. Pat. No. 4,853,188. The device is rotated in a centrifugal separator. According to the patent, the centrifugal separator is formed integrally by mold forming of synthetic resin thereby to be disposable. A base plate forming a portion of the device has an elasticity so as to be easily engaged with a collar provided on a holder in which the base plate is held.

In a different approach, A. E. Lorincz describes in U.S. Pat. No. 6,567,214 a microscope slide designed for on-site collection, staining and viewing of cells in biological fluid and tissue samples. According to the patent, the slide permits point-of-care screening in a matter of minutes of any biological fluid or tissue sample for presence of infectious agents, after which the slide can be transported to a central lab for culture and/or definitive identification.

All references cited in this specification are incorporated by reference herein where appropriate for teachings of additional or alternative details, features, and/or technical background. It can be understood that there are disadvantages to the various existing methods for depositing material specimens onto microscope slide. Although smearing is used routinely for cytochemical staining and differential cell counts in clinical hematology, it is difficult to automate it. As for the most common dropping method, the distribution of cells and the resulting density on the slide is unpredictable. With the Cytospin technique also described above, the initial sedimentation and the movement of supernatant liquid (70 in FIGS. 2a-2d) about the deposition on slide 30 may hinder the forming of a homogenous layer, which is not desirable. Furthermore, the movement of supernatant liquid 70 may wash off the weakly attached cells from the surface of the slide.

In order to avoid the irregular sedimentation problem of the Cytospin, there is also the Cytobucket technique. Cytobucket is generally used in research environment only to deposit fixed cells or nuclei on slides (See, for example, U.S. Pat. No. 5,985,595 by Krider, et al.). It consists of a centrifuge carrier that is made to fit a specific general use centrifuge and a reusable chamber. A regular slide of user choosing completes the assembly and forms the bottom of the chamber. The carrier fits a swing-out type rotor. The sample is loaded in the assembly (chamber-slide-holder) in a horizontal position, and the cell suspension is directly dispensed over the deposition area on the slide. The cell sedimentation pattern from the outset may reflect the distribution of cells in the dispensed suspension at zero reference gravity before the onset of centrifugation. If the initial suspension distribution is made to be random with appropriate mixing, then a random cell distribution can be achieved on the slide. When the assembly is accelerated, the carrier gradually turns vertical due to centrifugal force. As long as the lateral acceleration is not high, the cells generally remain attached to where they originally landed. Furthermore, as long as the meniscus of the carrier liquid is not large, the meniscus will not agitate and dislodge the cells as the centrifuge decelerates. Thus, the Cytobucket technique has the potential for optimal deposition of cells for automated scanning; however, with the drawbacks remedied, as described further in the embodiments of the present invention.

### SUMMARY OF INVENTION

The present invention involves a device for depositing materials on a custom made microscopy slide. The device comprises a deposition chamber that can be sealably adhered to and removed from the slide and can be disposable or reusable. The device can be used in an in vitro diagnostic testing environment, and is suitable for centrifugation.

One embodiment involves a device or an apparatus for depositing biological samples (including cells, organelles, extra-cellular and intra-cellular materials, mixtures), on a microscope slide. The microscope slide has a receiving area for a biological sample. The chamber has a top portion, a middle portion and a bottom portion. The bottom portion has a footprint configured to fit over the receiving area of the microscope slide. The middle portion may comprise a truncated polyhedron comprising four planar surfaces. The top portion has a cylindrical opening or port to allow the biological sample to be introduced to and aspirated from all areas of the slide surface. The invention provides a means, including, without limitation, closure or stopper material, for closing and sealing the port, and different means, including, without limitation, an adhesive material or fixation structure, for attaching the bottom portion of the chamber to the slide.

In one embodiment, the chamber is secured removably on to a microscope slide by using an adhesive. In another embodiment, the chamber is fitted with a sleeve-like flange that is pressed onto a receiving area of the microscope slide to removably seal the chamber against the slide.

In one embodiment, the chamber is pressed onto the microscope slide through a shell that fits over the chamber. The shell, enveloping the chamber and the microscope slide, is snapped into a centrifuge bucket. In another aspect, a compression plate is positioned over the cell deposition chamber, which in turn is actuated by a spring-loaded lever handle in a centrifuge bucket.

More specifically, one embodiment involves an apparatus comprising: a chamber having a footprint configured to fit over a receiving area on a microscope slide, the chamber having a top portion, a middle portion and a bottom portion, the top portion of the chamber defining an opening configured to allow a biological sample to be deposited on the surface of the microscope slide, and a closure structure for closing and sealing the opening. An aspect further involves a receiving area treated with an adhesive material, the adhesive material allowing the attachment and removal of the chamber from the microscope slide. Another aspect further comprises a liner that conforms to and fits the inside walls of the chamber; a neck portion of the liner that removably attaches to the opening of the chamber; a flange portion of the liner that removably attaches to an edge of the bottom portion of the chamber; a shell that conforms to and fits over the outside walls of the chamber; and a means for securing the chamber onto the receiving area on the microscope slide by pressing on the shell to seal the flange against the receiving area.

Another embodiment provides a method for depositing biological material in a cell deposition chamber. The method involves providing a microscope slide having a receiving area for deposition of biological sample and a cell deposition chamber with a footprint adapted to fit over the receiving area. A microscope slide is treated with a chemical backing comprising a hydrophobic substance.

In one aspect, an embodiment provides a microscope slide having a receiving area for a biological sample and a cell deposition chamber with a footprint adapted to fit over the receiving area, the chamber having an opening and a method for treating the microscope slide with a chemical backing; fitting the chamber with a liner, the liner having a neck that fits over the opening of the chamber, and a flange that fits over an edge of a bottom portion of the chamber; placing the chamber over the receiving area and securing the chamber on the microscope slide; introducing the biological material onto the microscope slide via the opening on the deposition chamber; closing and sealing a port at top of the chamber; performing an in vitro diagnostic testing of the biological sample; opening the port; and aspirating supernatant liquid of the biological sample through the port.

In another embodiment, a method further involves the steps of: closing and sealing the port at top of the chamber after aspirating the supernatant liquid; placing a compression plate over the chamber; actuating a handle to press the compression plate to seal the chamber onto the receiving area on the microscope slide.

### BRIEF DESCRIPTION OF DRAWINGS

FIG. 1 is a perspective drawing of a Cytospin device showing the assembly of a chamber, a slide and an holder bracket used in depositing of specimens on the slide during centrifugation, according to prior art.

FIG. 2a is a side view of the Cytospin of FIG. 1 showing the administering of a sample specimen into the chamber of the Cytospin, according to prior art.

FIG. 2b is a side view of the Cytospin of FIG. 2a during centrifugation, according to prior art.

FIG. 2c is a side view of the Cytospin of FIG. 2b during centrifugation showing the separation of the cells from the supernatant liquid specimen, according to prior art.

FIG. 2d is a side view of the Cytospin of FIG. 2c showing the deposition of cells onto the slide under the influence of centrifugation, according to prior art.

FIG. 3a is a top view and a side view of a microscope slide having a square receiving and containment area for placing a sample specimen for in vitro diagnostic testing, according to the present invention.

FIG. 3b is a top view and a side view of a microscope slide having a rectangular receiving and containment area for placing a sample specimen for in vitro diagnostic testing, according to the present invention.

FIG. 4a is a top view and a side view of an aspect of an embodiment of the present invention showing a cell deposition chamber having a square foot-print attached to a microscope slide also of the present invention, according to the present invention.

FIG. 4b is a top view and a side view of another aspect of an embodiment of the present invention showing a cell deposition chamber having a rectangular foot-print attached to a microscope slide also of the present invention, according to the present invention.

FIG. 5a is a perspective drawing of the cell deposition chamber of FIG. 4a, showing the assembly of the chamber with a square foot-print to the microscope slide, according to the present invention.

FIG. 5b is a perspective drawing of the cell deposition chamber of FIG. 4b, showing the assembly of the chamber with a rectangular foot-print to the microscope slide, according to the present invention.

FIG. 6 is a drawing of the assembly of the cell deposition chamber and microscope slide of the present invention, as a supernatant fluid in the chamber is being aspirated by a pipette, according to the present invention.

FIG. 7 is a drawing showing a multiplicity of cell deposition chamber assemblies of the present invention loaded on to a carrier for purposes of transportation and/or centrifugation, according to the present invention.

FIGS. 8a and 8b are drawings showing an embodiment of a disposable sleeve-like liner of the present invention that is used with the cell deposition chamber where the flange of the liner is sealed onto a microscope slide by pressing the chamber onto the slide surface by means of a shell that fits over the chamber.

FIG. 9 is a drawing of another embodiment showing the mounting of the cell deposition chamber of the invention onto a microscope slide through the use of a compression plate that presses the chamber onto the slide by means of a spring-loaded lever, or handle.

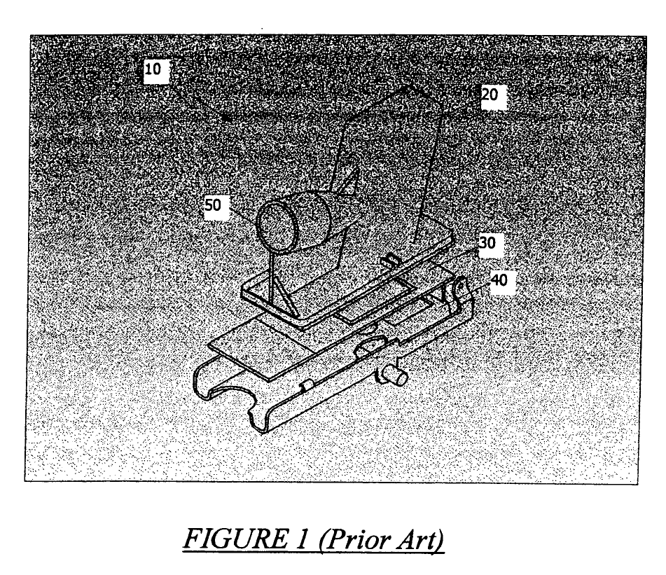

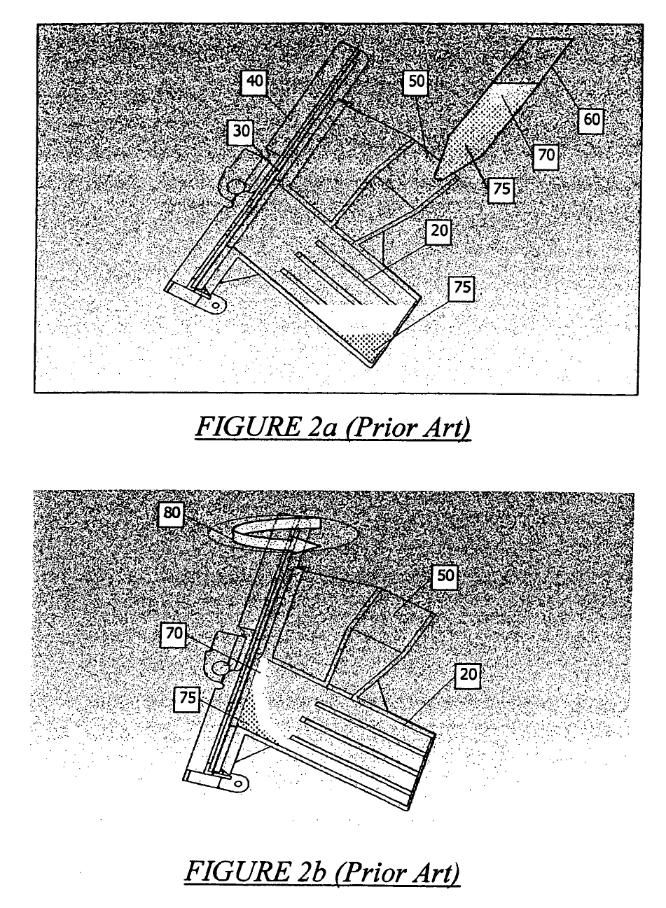

### DETAILED DESCRIPTION

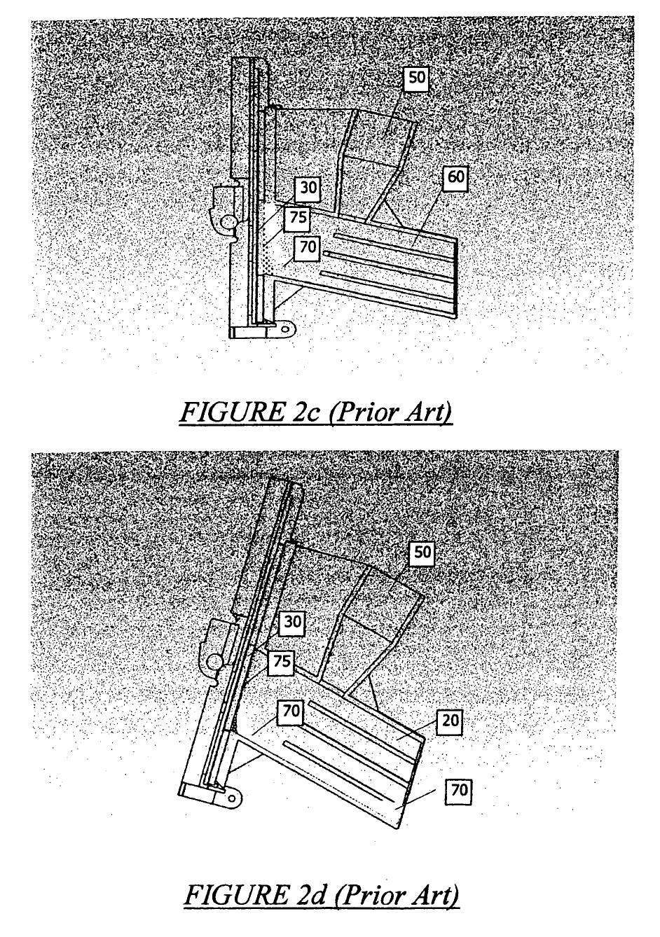

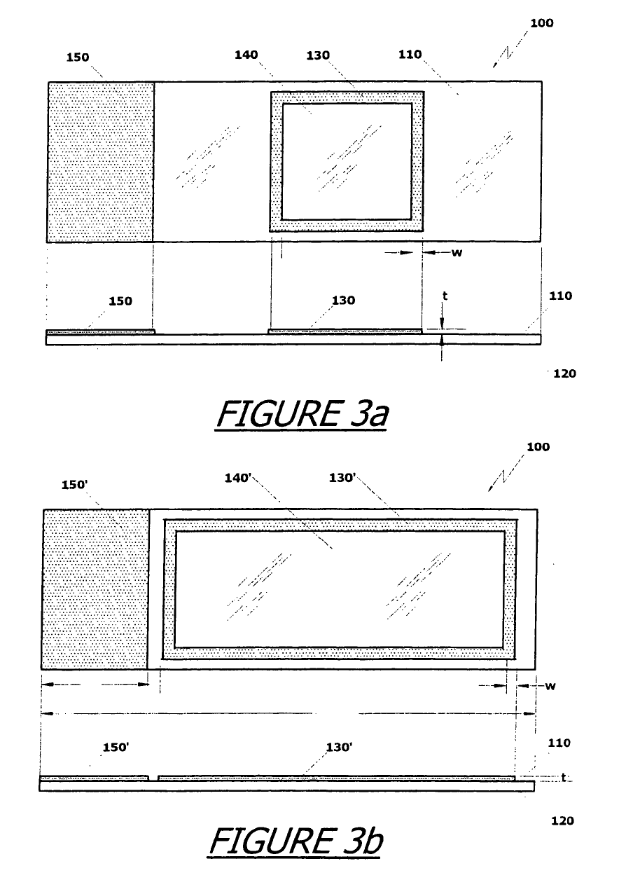

Referring now to the drawings, FIG. 3a shows a microscope slide having the general reference numeral 100. Though rectangular in shape as shown in FIG. 3a, it can be of different shapes depending upon the application. It may be made out of plastic or glass. The slide has a conventional length, width and thickness as is well known to one of ordinary skill in the art. FIGS. 4a and 4b show the cell deposition chambers of the present invention that are sealably mountable on the slides of FIGS. 3a and 3b, respectively. The chambers may be mounted adhesively, or by mechanical means alone, as described further in the embodiments of the present invention. Furthermore, depending upon the application, specimens may be introduced onto the slide either after or before mounting the chamber on the slide.

In general use, a sample specimen comprising an aqueous or non-aqueous liquid, liquid reagent, biological fluid and/or biological tissue section(s) is introduced onto a portion of the slide. Before performing analysis on the sample specimen using microscopy or other techniques, the sample on the slide or plate may be dried, placed in a fixative, or remain fresh prior to treatment for enhanced visualization by light, electron, or fluorescent microscopy, and/or including gross analysis with the human eye. The sample may be analyzed in its natural state or may need treatment with one or more liquid dyes to enhance visualization. Further treatment with molecular biological techniques may include, for example, treatment by monoclonal, polyclonal antibodies, in-situ hybridization by molecular probes, and/or their liquid detection reagents. During routine analysis or manipulation of a slide, the sample or liquid reagent may spill from the slide, run or migrate onto other portions of the slide, and/or “wick off” if the slide touches another object, thus resulting in a loss of all or part of the liquid sample or reagent. It is desirous to avoid such inadvertent spillage or undesired mixing or contamination of different samples or liquid reagents. The embodiments of the present invention described below provide not only regions of containment defined by borders for inhibiting migration of liquids or liquid samples thereon, but also a chamber affixed over the containment borders in order to avoid spilling the sample when transporting the slide or when the slide is subjected to centrifugation for deposition of cells in the sample onto the slide, for example The chambers of the invention may be disposable or nondisposable depending upon the application, as described in the embodiments below.

In an embodiment shown in FIG. 3a, slide 100 has an upper surface 110 and a lower surface 120 as seen in the side view of the slide in the same FIG. 3a. Disposed upon a portion of the upper surface 110 is a liquid containment border 130 which has a square shape, though it can be any other shape, such as rectangular, circular, triangular, trapezoidal, etc. For example, FIG. 3b shows the same slide 100 prepared with a rectangular liquid containment border 130′. It will be understood by those skilled in the art that the shapes of the containment areas, for receiving sample specimens, are not limited only to those shown in the Figures herein. The shapes may be circular or polygonal, for example. The corresponding chamber has a footprint that mates the containment border. The chamber may be used to deposit a sample of specimen(s) onto the slide, or introduce other agents to affect the specimen(s) that may have already been placed on the slide.

The containment border 130 or 130′ in FIG. 3a or FIG. 31b, respectively, surrounds a receiving and containment area 140 or 140′, respectively, of the upper surface 110 of slide 100. The containment border 130 (130′) forms a liquid barrier about the containment area 140 (140′). When a liquid or liquid sample (not shown) is introduced into the containment area 140 (140′) of slide 100 for analysis, the containment border 130 (130′) prevents the spreading, leakage or migration of the liquid or liquid sample from the containment area 140 (140′), thus causing the sample to be retained in a discrete and confined location upon the slide 100. Where used herein, the term liquid or liquid sample is intended to refer to a liquid material, or a liquid biological sample (e.g., blood, urine, plasma, or cerebrospinal fluid) which is desired to be localized on the slide.

In an aspect of embodiments shown in FIG. 3a and FIG. 3b, slide 100 further has a distinct marking area 150 for writing upon or for attaching a label thereto. The portion of the slide where the marking area is formed may be “frosted”, i.e., etched off or abraded, or, in the alternative, may be an opaque epoxy or painted coating. Other means of forming a marking surface will be apparent to one of ordinary skill in the art.

The material which forms the containment border 130 may be a composition comprising a liquid repellant compound dissolved in a volatile solvent. For example, the composition may be an alkyl polysiloxane and a mineral acid mixed with a solvent in a manner well known in the art. Other polysiloxanes, silicones and silicon fluids which can permanently or at least substantially permanently bond to a glass surface and function in accordance with the present invention can be used.

Furthermore, the containment border material has a thickness t and width w which provide optimum cell deposition characteristics both in steady state as well as in motion, such as during centrifugation. It is preferred that the thickness of the border is from about 0.01 to about 0.2 millimeters (mm), and the width is from about 1 to about 2.5 mm. It will be understood by those skilled in the art that when a suspension is placed in the containment area, it is in some applications desirous to have the maximum density of cells settle onto the slide. In order to achieve this result, the suspension should be of a thickness that is as close to as a monolayer of the cells as possible. For, an excessive amount of the suspension will result in conglomeration of cells that may interfere with each other in settling vertically onto the slide. One aspect of an embodiment involves a measured vibration of the sample in suspension on the slide to assist cells pass each other without forming clusters in settling onto the slide. At the same time, the suspension in the containment area is of such predetermined volume so as to not flow over the height of the dam provided by the thickness of the containment border. It is understood that the volume of the suspension liquid will depend upon the area of the containment area and the thickness of the containment border.

Although the microscope slide of the present invention can be used for in situ analysis of the cells in steady-state, as deposited on the slide in the absence of further imposition of g-forces (artificial gravitational forces), such as through additional vibration or centrifugation, it is also desirable to be able to mount the slide on a centrifuge should higher density of cells be required. It is for this purpose, and also for general purpose of providing a spill-proof cover while handling the slide, an aspect of an embodiment involves a chamber that can be sealably mounted, as well as dismounted, onto the slide. Two different chambers are shown in FIGS. 4a and 4b. The chamber shown in FIG. 4a has a square foot-print, while the chamber shown in FIG. 4b, a rectangular foot-print, corresponding to the containment areas on the two slides in FIGS. 3a and 3b, respectively. It will be understood, however, that the foot-print of the chambers can vary depending upon the shape of the containment areas for which they are designed.

The square based chamber 160 shown in FIG. 4a as well as the rectangular based chamber 160′ shown in FIG. 4b, both have a top portion (170, 170′), a middle portion (180, 180′) and a bottom portion (190, 190′). The top portion comprises an opening or port with a cylindrical shape. The middle portion comprises a truncated polyhedron having four planar surfaces. The bottom portion has an adhesive to adhere the chambers onto their respective slides. The chambers are mounted adhesively, or by mechanical means alone, onto their respective slides either prior to or after the specimens have been introduced onto the containment areas of the slides. After the completion of initial tests and analyses, the supernatant liquid inside the chamber is removed. An aspect of an embodiment provides an opening for each chamber configured such that all areas of the containment area under the chamber can be aspirated by a Pasteur pipette or similar aspirator device. Furthermore, the invention provides a mechanism to close the opening, such as a stopper, including a cap or a plug, so that it renders the device leak proof even when the device comprising the slide and the chamber is inverted.

In the schematic of the cell deposition devices shown in FIGS. 4a and 4b, a standard (76×25.5×1 mm) glass slide 100 with frosted marking area 150 is used. Commensurate with this type of standard glass, dimensions of the square chamber in FIG. 4a may comprise, for example, from about 20 to about 23 mm, on a side, a. The height, b, of the chamber to the top of the stopper (not shown) may be between, for example, about 15 to 20 mm. The corresponding dimensions c, d and e for an embodiment shown in FIG. 4b may be respectively, for example, from about 24 to about 25 mm, from about 55 to 58 mm, and from about 18 to 20 mm. It will be understood, however, that the alternatives cited above are not intended to limit the invention to these embodiments. On the contrary, the invention is intended to cover alternatives, modifications and equivalents, which may be included within the spirit and scope of the invention as defined by the appended claims.

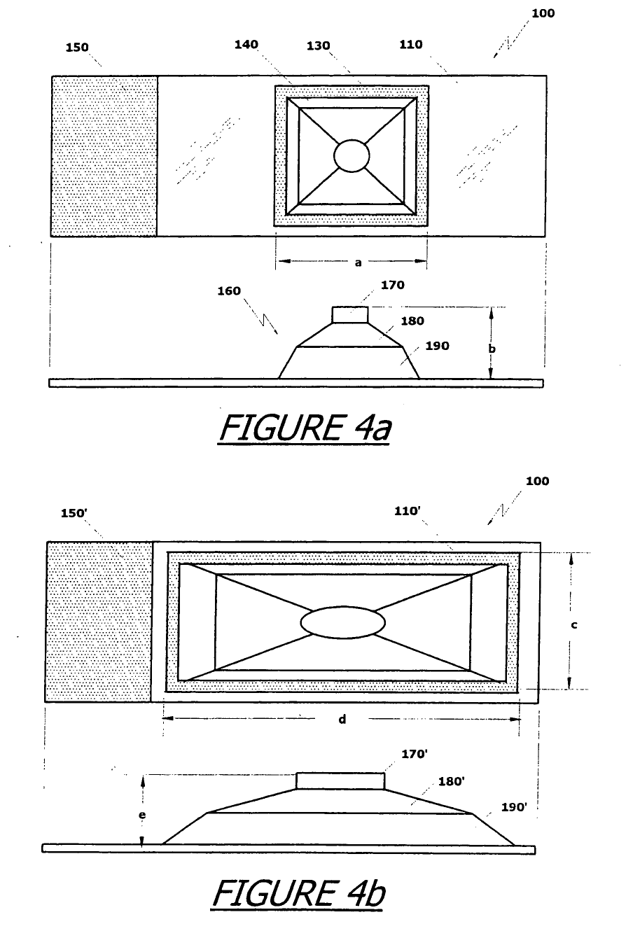

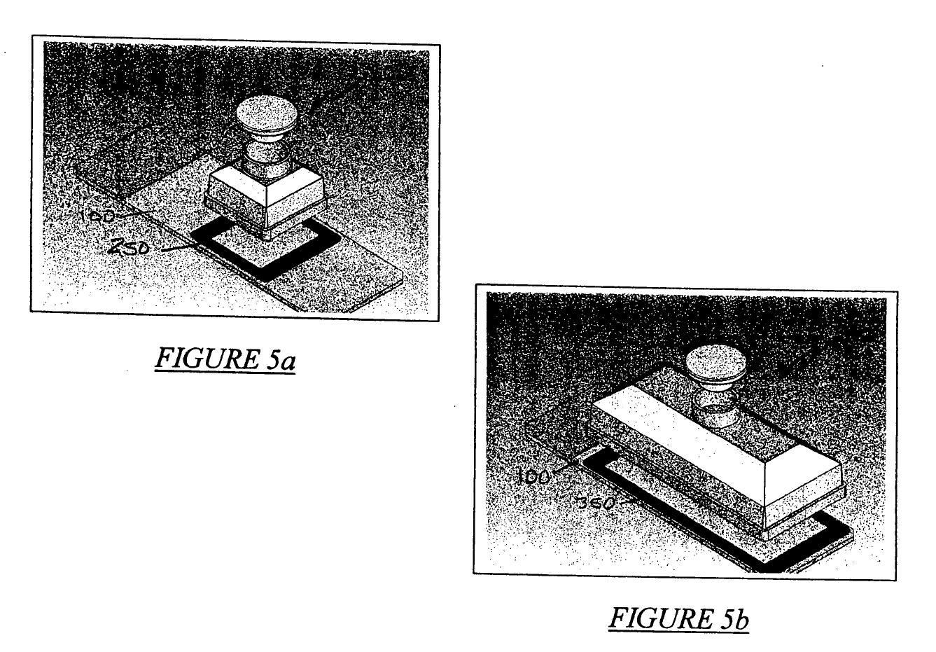

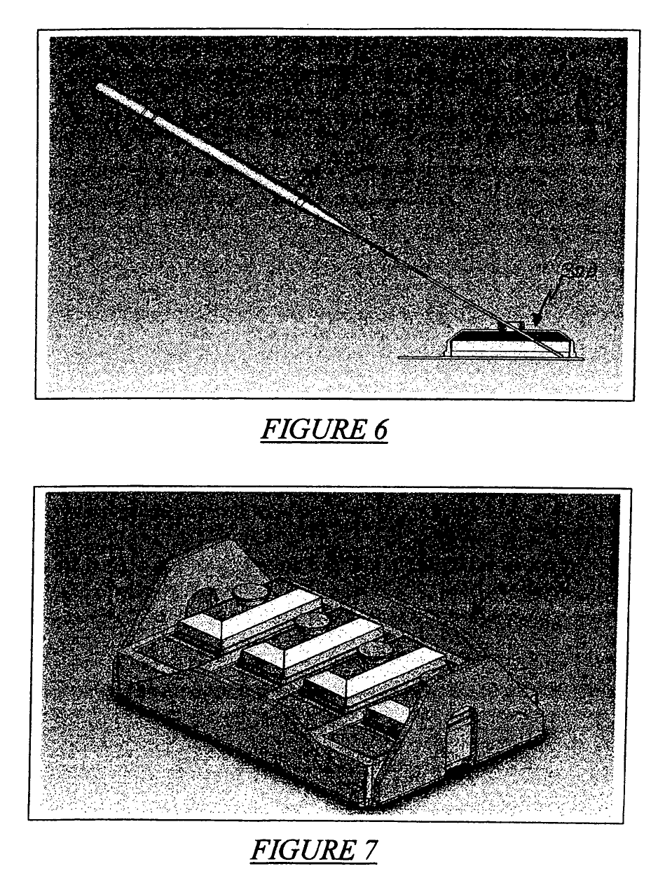

A three-dimensional rendition of the cell deposition devices of the present invention are depicted as shown in FIGS. 5a and 5b. Both the square 200 and rectangular 300 chambers are adaptable to standard glass slides. The devices are used for depositing amniotic fluid or other cells from aqueous suspension onto a customized standard glass slide 100. The devices can be disposable, single use only, and used in an in vitro diagnostic test. Each chamber is sealably mountable/dismountable to a receiver/containment area as described above. In an aspect of an embodiment, a biocompatible acrylic adhesive is used to attach the chambers to their respective slides. The adhesive has a strength to withstand 660 g swing bucket centrifugation with maximum liquid volume of aqueous medium in the chamber. At the same time, the adhesive allows the removal of the chamber from the slide after centrifugation either by hand or by using a two-pronged wedge type removal tool. A chemical backing which is hydrophobic and with a shape corresponding to the footprint of the chamber is attached to the slide at borders (250, 350) to assist in adhesive function and to form a reagent dam to minimize reagent consumption. The thickness of the backing material is applied such that when a coverslip (not shown) is attached on the slide following chamber removal, the clearance between the coverslip and the slide surface does not exceed 0.2 mm. Furthermore, the openings at the top of each chamber shown in FIGS. 5a and 5b are configured such that all areas of the slide surface can be aspirated by a Pasteur pipette or similar aspirator device, preferably with an outside diameter from about 2 to 2.5 mm. An aspirator 400 in chamber 300, prior to being opened after centrifuging, is shown in FIG. 6. FIG. 7 shows a multiplicity of chambers 300 loaded onto a carrier 500 for transport to a centrifuge station.

In operation, a slide 100, such as shown in FIGS. 3a and 3b, with our without special coatings, are prepared with appropriate containment areas (140, 140′) having containment boundaries (130, 130′) including hydrophobic backing. Next, a deposition chamber having a foot-print the same shape as the receiving containment boundaries is lowered onto the slide surface and adhered to the boundaries with a biocompatible acrylic adhesive. A sample comprising a cell or organelle-microscopic structures in a cell that have specialized functions, e.g., mitochondria and the nucleus-suspension is then introduced into the chamber by pipetting through an opening in the top portion (170, 170′ in FIGS. 4a and 4b) of the chamber. If the sedimentation of cells onto the slide surface is adequate during the initial deposition (and tapping or vibration) of the suspension onto the slide, then the supernatant liquid now inside the chamber is aspirated by pipette 400 as shown in FIG. 6. Subsequently, the cylindrical opening shown at the top of the chamber can be closed shut with a stopper, such as a cap or a plug, and the assembly device can be transported elsewhere, if need be, for further analysis of the specimens on the slide. For example, the thusly assembled device can be readied for centrifugation on any standard centrifuge. At point of analysis, the chamber can be removed by hand or by a tool, to expose the cells on the slide for further analysis, such as under a microscope.

As described earlier, the cell deposition chamber will swing outwardly in the centrifuge housing until finding a vertical position under the influence of centrifugal forces. It will be obvious to those skilled in the art that with the centrifugal forces acting normal to the containment area on the now vertical slide, the cells in the suspension will spread out relatively evenly over the containment area and be deposited onto the slide surface. Subsequent to a predetermined period of centrifugation, the device is removed from the centrifuge. Then, the stopper of the opening on the chamber is removed, and any supernatant fluid is aspirated from the surface of the slide with the aid of a pipette. It will be understood by workers in the field that the cell deposition chamber of the present invention allows the pipette reach all corners of the chamber so that all areas within the containment boundaries are totally aspirated. It will also be understood that the embodiments of the present invention provide the highest possible cell density 2400 cells/mm² while at the same time providing a clear view of cells under the microscope. This is possible because the containment area is well-defined, and the volume of suspension can be prepared precisely commensurate with the particular specimens used, thus improving upon density and clear viewing of cells as a truly monolayer deposition is reached.

In one aspect, the removable chambers shown in FIGS. 4a-7 are not nondisposable, that is, are not reusable because the inside walls of the chambers get soiled with the introduction of sample specimens, and it is very difficult to clean them. In another aspect, the present invention provides an additional removable structure, or liner, that lines the inside walls of the disclosed chambers such that the liner can be disposed of after each use following the separation of the slide from the liner and its chamber.

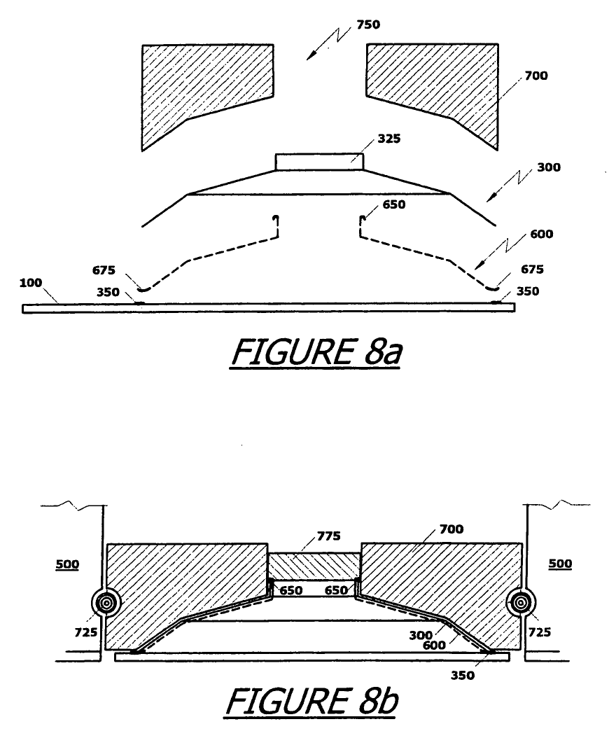

In an embodiment shown in FIGS. 8a and 8b, such a liner 600 is provided. The liner is made to conform to the inside contours of chamber 300 and has collar 650 to hook over the neck 325 of the chamber as shown in FIG. 8a. Furthermore, liner 600 has a flange edge 675 which hooks over the lower edge 375 of chamber 300 such that when collar 650 and flange 675 are engaged to their counterparts on the chamber, the liner fits snugly along the inner walls of the chamber. The liner can be made out of a disposable material, such as an elastomer or plastic comprising polypropylene or polystyrene. When lowered onto slide 100, flange 675 mates with border 350 (see also FIG. 5b) on slide 100 to provide a pressure seal against the slide. The pressure is provided by a shell 700 that conformally envelopes chamber 300 where the shell can be engaged in any number of ways with carrier 500 shown in FIG. 7 to provide the necessary force to hold the chamber-liner sub-assembly sealably against slide 100. For example, a spring-loaded ball bearing 725 partially protruding from a cavity on the side of shell 700 can be made to snap into a detent 550 on the side wall of carrier 500, thus holding the chamber-liner sub-assembly on the slide in the carrier. The shell can be made out of metal, or plastic, sufficiently rigid to provide stability to the assembly and also provide holding power over the slide.

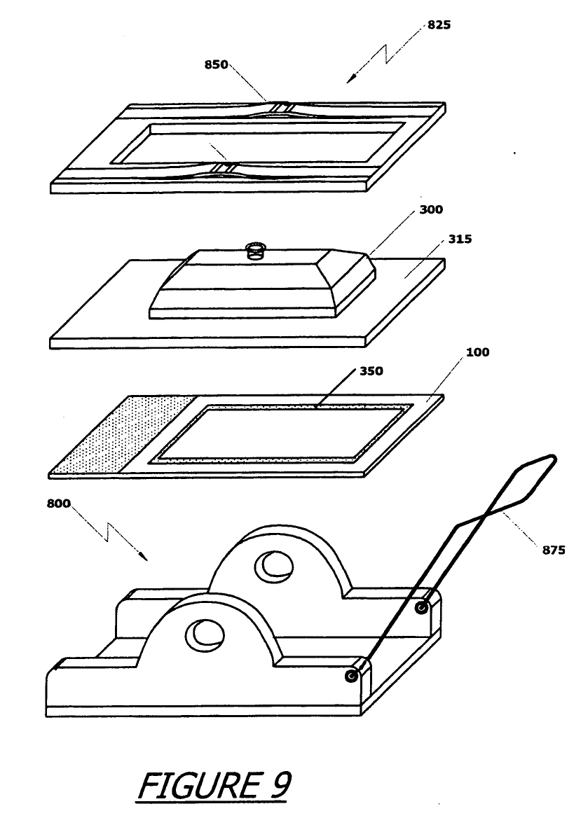

FIG. 9 shows another embodiment of an assembly comprising cell deposition chamber 300 on slide 100 in a carrier 800 with a spring-loaded handle 875. Carrier 800 is configured to accept chamber 300 and its associated slide 100 as depicted in FIG. 9. Chamber 300 is lowered to mate slide 100 with an intervening gasket 315. Gasket 315 comprises an elastomeric material that provides cushioning between the chamber and the slide, while at the same time sustaining a sealable and yet removable joint between the chamber and the slide. The pressure for the seal is provided by a compression plate 825 having camber 850 which is compressed over the periphery of the gasket 315 by a spring-loaded handle 875 that engages the assembly into carrier 800. It will be noted that both embodiments shown in FIGS. 8a and 8b, are configured to provide cell deposition onto the slide after assembly through opening 325 which can subsequently be capped in any number of ways as stated earlier. In FIGS. 8a and 8b, access to opening 325 is provided through another opening 750 in shell 700, which in turn can be capped by stopper 775.

It will be understood by those skilled in the art that in addition to the advantages of having a reusable chamber as disclosed in the embodiments above, there is also the additional advantage of not having an adhesive in assembling the chamber onto the slide. As there is no adhesive, the cell deposition chamber can accommodate samples of specimens in a variety of solvents that might not be compatible with the adhesive based units. User specified slides within certain ranges can also be accommodated since the slides need not have adhesive borders to accept a chamber. The deposition surface can be modified without any interference from adhesive borders as there would be none.

Further, in situations where slides already deposited with solid tissue samples (e.g., particulates, cell mixtures, extra-cellular products, intra-cellular constituents, non-homogeneous populations), the samples can be dispersed and fragmented in the chamber of the present invention without having to transfer them to another container. This is accomplished by assembling the deposition chamber 300 over the slide using the shell 700 technique of FIG. 8b or handle mechanism 875 of FIG. 9 and performing tissue processing right in the chamber. The processing can be accomplished, for example, by adding dissociation reagents (e.g., protease solution such as collagenase) in the chamber. After incubating the dissociation mixture, and finally neutralizing the dissociation reagent, the resulting suspension could then be directly deposited on the slide by centrifugation. The supernatant will then be removed and chamber disassembled.

Disposable cell deposition chamber of the present invention can be used as a platform for cell based assays. These include at least the following types of assays:
1. The slide chamber is used to harvest cells that have a capability to acquire an analyte from the liquid medium surrounding them. The analysis is carried out by incubating live or fixed cells with a solution to be analyzed. The cells are either attached to the slide or are centrifugally deposited after the incubation. The cells are then analyzed for the analyte content by fluorescence microscopy or other means subsequent to immunostaining or other means of rendering analyte presence fluorescent.
2. Slide chamber is used to harvest cells that can interact with an analyte present in the surrounding medium. The interaction generates a response in cells. The cells can be analyzed on the slide or after depositing on the slide for the response using a microscopic technique i.e. immunofluorescence microscopy.
3. Cell deposition chamber can be used in panning e.g. the slide would be coated with a reagent that specifically binds to a specific class of cells depending on the biochemical structures present at their surfaces. This reagent can be an antibody or a lectin. In this case the cell suspension would be added to the chamber containing a reagent coated slide. The cell suspension would be allowed to settle in the chamber while the chamber would be agitated so as to keep those cells that are not attached to the slide by specific interaction from non-specifically adhering to the slide. After a predetermined time the supernatant, containing non-adherent cells, would be removed. The chamber assembly would then be centrifuged (if needed) and disassembled.
4. Deposition chamber can be used in preparing a slide from an environmental sample. Analytes could consist of particulate matters other than cells e.g. soil particles or pollutant particles.
5. Cell deposition chamber can be used in forensic sample preparation, to analyze particulate samples.

Though these numerous details of the disclosed apparatus and method are set forth here to provide an understanding of the present invention, it will be obvious, however, to those skilled in the art that these specific details need not be employed to practice the present invention. At the same time, it will be evident that similar components may be employed in other similar apparatus that are too many to cite, such as, for example, in the well-known CytoSpin devices which are used in clinical routine diagnostics. The shell 700 of FIGS. 8a and 8b can be adapted to accommodate the cell deposition chamber of the present invention to the cytobucket.

While the invention has been particularly shown and described with reference to particular embodiments, those skilled in the art will understand that various changes in form and details may be made without departing form the spirit and scope of the invention.

What is claimed is:

1. An apparatus comprising:
a chamber defining a void and having a footprint configured to fit over a receiving area on a microscope slide, said chamber having a top portion, a middle portion and a bottom portion, said top portion defining an opening of said chamber to allow a biological sample to be deposited on the surface of said microscope slide;
a means for closing and sealing said opening; and
a means for attaching said chamber to said receiving area on said microscope slide.

2. The apparatus according to claim 1, wherein said chamber has an open bottom with a polygonal footprint.

3. The apparatus according to claim 1, wherein said footprint is circular.

4. The apparatus according to claim 1, wherein said top portion of said chamber comprises a cylindrical shape.

5. The apparatus according to claim 1, wherein said means for closing and sealing said opening is a cap.

6. The apparatus according to claim 1, wherein said means for closing and sealing said opening is a plug.

7. The apparatus according to claim 1, wherein said middle portion of said chamber comprises a truncated polyhedron to allow said biological sample to be aspirated from all areas of said slide surface.

8. The apparatus according to claim 7, wherein said polyhedron comprises four planar surfaces.

9. The apparatus according to claim 1 further comprising:
a receiving area treated with an adhesive material,
said adhesive material allowing the attachment and removal of said chamber from said microscope slide.

10. The apparatus according to claim 9, wherein adhesive comprises a biocompatible acrylic material.

11. The apparatus according to claim 9, wherein said receiving area is treated with a hydrophobic backing to promote adhesive function.

12. The apparatus according to claim 9, wherein said receiving area is treated with a hydrophobic backing to form a reagent dam.

13. The apparatus according to claim 1 further comprising:
a liner configured to fit the inside walls of said chamber and having a neck portion that removably attaches to said opening of said chamber, as well as a flange portion that removably attaches to an edge of said bottom portion of said chamber; and
a shell that conforms to and fits over the outside walls of said chamber.

14. The apparatus according to claim 13, wherein said liner comprises a disposable polyethylene.

15. The apparatus according to claim 13, wherein said shell comprises polyethylene.

16. The apparatus according to claim 13, further comprising a means for securing said chamber onto said receiving area on said microscope slide by pressing on said shell to seal said flange against said receiving area.

17. An apparatus in accordance with claim 16, wherein the means for securing said chamber comprises a handle which engages a compression plate positioned over said chamber.

18. A method for depositing biological material in a cell deposition chamber comprising the steps of:
providing a cell deposition chamber having a footprint at a bottom portion of said chamber and defining an opening at a top portion of said chamber;
providing a microscope slide having a receiving area for a biological sample, said receiving area adapted to match the footprint of said cell deposition chamber;
treating said microscope slide with a chemical backing;
fitting said chamber with a liner, said liner having a neck that fits over said opening of said chamber, and a flange that fits over an edge of said bottom portion of said chamber;
placing said footprint of said chamber over said receiving area and securing said chamber on said microscope slide;
introducing biological material onto said microscope slide via said opening of said deposition chamber,
closing and sealing said opening.

19. A method according to claim 18, wherein said biological sample comprises cells in a suspension liquid.

20. A method according to claim 18, wherein said biological sample comprises organelles in a suspension liquid.

21. A method according to claim 18 further comprising the steps of:
performing an in vitro diagnostic testing of said biological sample;
opening said port; and
aspirating supernatant liquid of said biological sample through said port.

22. A method according to claim 21 further comprising the steps of:
closing and sealing said port at top of said chamber after aspirating said supernatant liquid;
placing a compression plate over said chamber;
actuating a handle to press said compression plate to seal said chamber onto said receiving area on said microscope slide.

23. The method according to claim 22, wherein said handle seals said chamber onto said slide in a cytocentrifugation bucket.
